(19) United States
(12) Patent Application Publication
(10) Pub. No.: US 2021/0155089 A1
(43) Pub. Date: May 27, 2021

(54) Vehicle Glass Protective Cover

(71) Applicants: Trak Jackson, Albuquerque, NM (US); Janelle Jackson, Albuquerque, NM (US)

(72) Inventors: Trak Jackson, Albuquerque, NM (US); Janelle Jackson, Albuquerque, NM (US)

(21) Appl. No.: 17/082,349

(22) Filed: Oct. 28, 2020

Related U.S. Application Data
(60) Provisional application No. 62/940,621, filed on Nov. 26, 2019.

(51) Int. Cl. B60J 11/08

(52) U.S. Cl. CPC B60J 11/08

(57) ABSTRACT

A vehicle glass protective cover is shown and described. The vehicle glass protective cover includes a first layer of protective material. A second layer of adhesive material is attached to a bottom side of the first layer of protective material. The first layer of protective material is proportioned to fit a motor vehicle. A third layer of tinting material is attached to the first layer of protective material.

### CROSS REFERENCE TO RELATED APPLICATIONS

This application claims the benefit of U.S. Provisional Application No. 62/940,621 filed on Nov. 26, 2019. The above identified patent application is herein incorporated by reference in its entirety to provide continuity of disclosure.

### BACKGROUND OF THE INVENTION

The present invention relates to vehicle glass protective covering. More particularly, the present invention provides a covering for vehicle glass that is replaceable.

There is a constantly debris flying around on roadways. Large vehicles in particular spray debris up and onto smaller vehicles. Vehicle windshields can be fragile, becoming cracked or damaged with debris flying errantly at the vehicle while in motion. These debris can further cause chips to be taken out of the windshield. Other areas of the vehicles glass may become cracked as a result of these debris as well.

Even small cracks and dents can force the vehicle owner to replace the windshield. Broken windshields can be extremely costly to replace. Many times, if a windshield is not immediately replaced the damage becomes worse. This means that broken vehicle glass will need to be replaced immediately or the problem may become exponentially worse.

Consequently, there is a need for an improvement in the art of protecting vehicle glass. The present invention substantially diverges in design elements from the known art while at the same time solves a problem many people face when having a crack in vehicle glass. In this regard the present invention substantially fulfills these needs.

### SUMMARY OF THE INVENTION

The present invention provides a vehicle glass covering wherein the same can be utilized for providing convenience for the user by avoiding damage such as a crack in vehicle glass. The vehicle glass protective cover is comprised of a first layer of protective material. A second layer of adhesive material is attached to a bottom side of the first layer of protective material. The first layer of protective material is proportioned to fit a motor vehicle.

Another object of the vehicle glass protective cover is to provide a first layer of protective material comprising tempered glass.

Another object of the vehicle glass protective cover is to provide an adhesive that will hold the first layer of protective material in place after an impact.

Another object of the vehicle glass protective cover is to provide a first layer of protective material that has a force absorbing quality.

Another object of the vehicle glass protective cover is to provide an adhesive material that has a force absorbing quality.

Another object of the vehicle glass protective cover is to provide a third layer of tinting material attached to the first layer of protective material.

Another object of the vehicle glass protective cover is to provide a tinted material that has a polarization element.

Another object of the vehicle glass protective cover is to provide cutouts specifically placed in the protective material that will form together when the cover is bent to fit over a bent portion of vehicle glass.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an in-use view of an embodiment of the vehicle glass protective cover.

FIG. 2 shows an in-use view of an alternative embodiment of the vehicle glass protective cover.

FIG. 3 shows a cross-sectional view of an embodiment of the vehicle glass protective cover.

FIG. 4 shows a perspective view of an embodiment of the vehicle glass protective cover.

### LIST OF REFERENCE NUMERALS

With regard to the reference numerals used, the following numbering is used throughout the drawings.
101 Protective covering
101a windshield protective covering
101b Front window protective covering
101c Rear window protective covering
102 Vehicle
102a Vehicle windshield
102b Vehicle front window
102c Vehicle rear window
301 Protective layer
302 Adhesive layer
401 Slits in protective covering
402 Edges of the slits in protective covering

### DETAILED DESCRIPTION OF THE INVENTION

Reference is made herein to the attached drawings. Like reference numerals are used throughout the drawings to depict like or similar elements of the vehicle glass protective cover. For the purposes of presenting a brief and clear description of the present invention, a preferred embodiment will be discussed as used for the vehicle glass protective cover. The figures are intended for representative purposes only and should not be considered to be limiting in any respect.

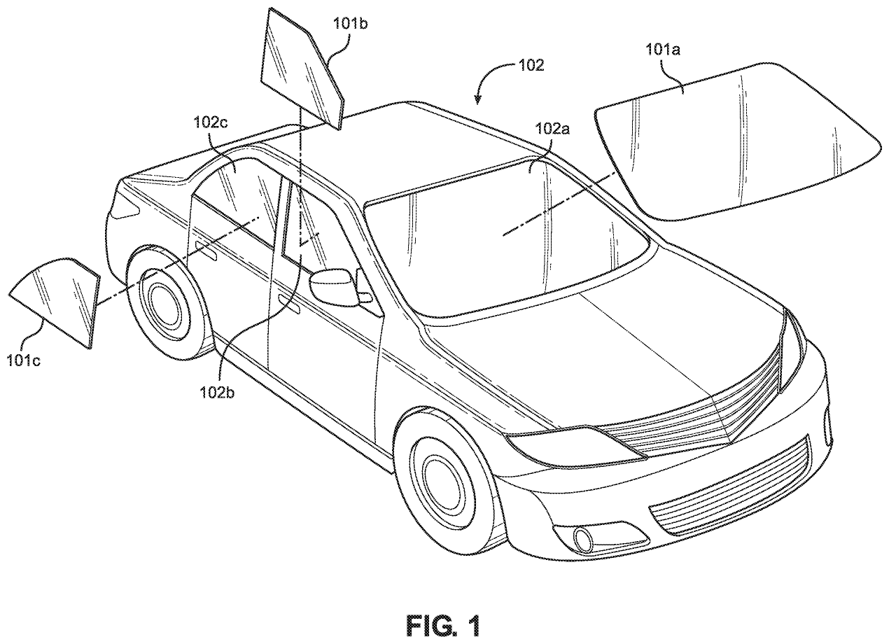

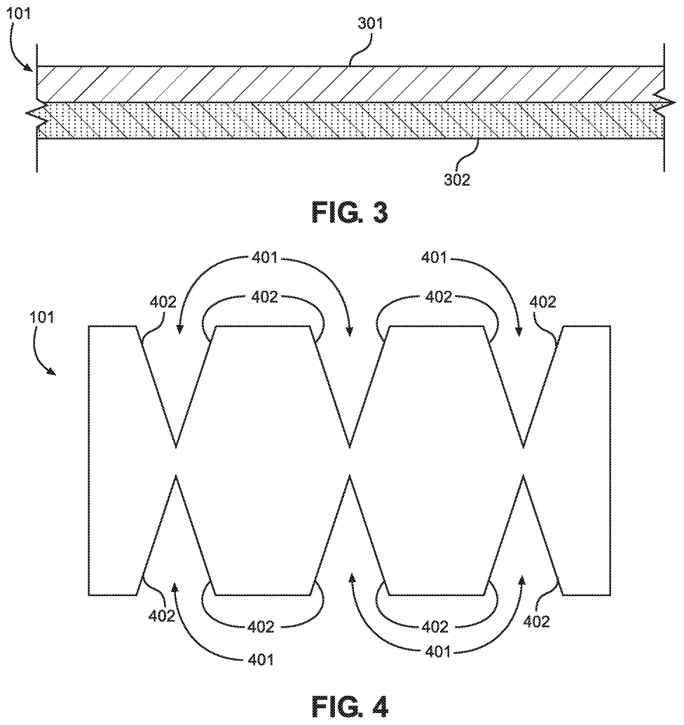

Referring now to FIG. 1, there is shown an in-use view of an embodiment of the vehicle glass protective cover. The vehicle glass protective cover includes at least one protective cover 101a, 101b, 101c for the windows of a motor vehicle 102. The protective covers 101a, 101b, 101c are configured to prevent damage from impacts of flying debris as explained in the description of FIG. 3. In other embodiments only one window of the motor vehicle 102a, 102b, 102c is covered. This will allow a user to decide which windows to have protected.

In the shown embodiment the first protective cover 101a is proportioned to fit on the windshield 102a of the motor vehicle 102. This will protect the windshield 102a from becoming damaged due to debris. Further, each window of the motor vehicle 102b, 102c has a protective cover 101b, 101c proportioned to fit over the respective window. The protective covers 101b, 101c will protect the windows 102b, 102c from becoming damaged. The protective covers 101b, 101c will be attached to the windows 102b, 102c of a motor vehicle 102 as described in the description of FIG. 3. In other embodiments the protective cover 101 is proportioned to it windows of different respective motor vehicles. This will allow the protective cover 101 to fit all makes and models of motor vehicles.

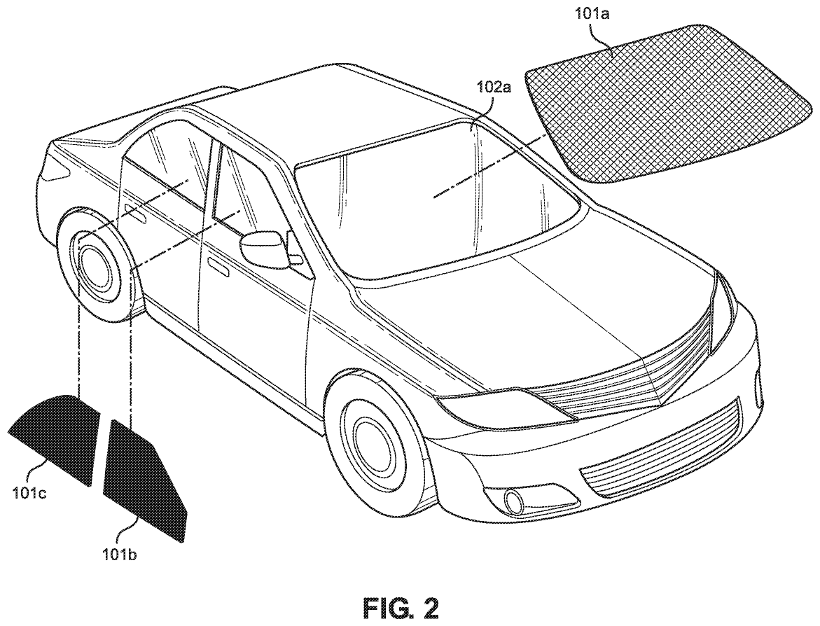

Referring now to FIG. 2, there is shown an in-use view of an alternative embodiment of the vehicle glass protective cover. In one embodiment the protective cover 101a, 101b, 101c has a tinting element. In different embodiments the tinting element has a different level of tint. In the shown embodiment the windshield cover 101a has a lighter tint. This will allow for a driver to more easily see out of the windshield 102a. The window protective covers 101b, 101c have dark tint elements included. This will help to reduce light entering the r rotor vehicle.

In one embodiment the tint levels are variable within one cover. This will allow for example a tint to be darker at the top of the protective cover and lighten toward the bottom of the protective cover. In some embodiments different levels of tint are used to comply with vehicle laws. In other embodiments the different tint levels are used for aesthetic reasons.

In other embodiments the protective covering 101a, 101b, 101c further includes additional elements. In one embodiment the protective covering 101a, 101b, 101c includes a polarized element. In yet another embodiment the protective covering 101a, 101b, 101c has a water repelling aspect.

Referring now to FIG. 3, there is shown a cross-sectional view of an embodiment of the vehicle glass protective cover. The shown embodiment of the protective covering 101 shows two layers of the protective covering 101. The first layer is the protective layer 301. The second layer is an adhesive layer 302. In other embodiments there will be additional layers to, for example, add the tinting effect as described in FIG. 2. In one embodiment the tinting layer is added to a top side of the protective layer 301. In other embodiments the tinting layer is added between the protective layer 301 and the adhesive layer 302.

The protective layer 301 will partially absorb impacts. In one embodiment the protective layer 301 will withstand impacts protecting the vehicle glass. In other embodiments the protective layer 301 is designed to take the kinetic energy of a flying object and break the protective layer 301 horizontally instead of vertically. This will allow the otherwise harmful energy a flying object to be directed sideways and away from the vehicle glass. In one embodiment the protective layer 301 is made up of safety glass. In another embodiment the protective layer 301 is made of a tempered glass.

The adhesive layer 302 will secure the protective layer 301 to the motor vehicle glass. In one embodiment the adhesive layer 302 is a heat activated layer. In another embodiment the adhesive layer 302 will need to set. In yet another embodiment the adhesive layer 302 will stick on contact with the motor vehicle glass. In some embodiments the adhesive layer 302 will not leave a residue on the motor vehicle glass when the protective cover is removed.

In some embodiment the adhesive layer 302 has a kinetic energy absorbing quality. In one embodiment the adhesive layer 302 is a gel type adhesive. This will allow for some of the kinetic energy to be absorbed into the adhesive layer 302. This will further protect the vehicle glass. In other embodiments the adhesive layer 302 has varying thicknesses. The thicker the adhesive layer 302 the higher the absorption properties.

In further embodiments the adhesive layer 302 will hold the protective layer 301 in place even if the protective layer 301 is damaged or broken. In other embodiments the adhesive layer 302 will allow the protective layer 301 to break away once broken. In yet a further embodiment the adhesive layer 302 will have an elastic effect. This will allow the protective layer 301 to separate upon impact to better absorb kinetic energy. The adhesive layer 302 will then pull the protective layer 301 back to its original position.

Referring now to FIG. 4, there is shown a perspective view of an embodiment of the vehicle glass protective cover. Many pieces of motor vehicle glass are curved. This curve could make installing the protective covering difficult if the protective cover 101 were to be in one continuous part. In one embodiment the protective cover 101 has a plurality of slits 401 therein. The slits 401 will allow the protective cover 101 to be easily curved to match the contour of the vehicle glass. When the protective cover 101 is curved and placed on the vehicle glass each edge 402 defined on opposing sides of the slits 401 will meet. This will form one continuous protective layer 101 over the vehicle glass. When the edges 402 of the slits 401 are brought together the slits 401 will be removed such that the entire section of vehicle glass is protected. In the shown embodiment the slits 401 are triangular and uniform however other slits 401 are envisioned as part of this disclosure to fit all variety of motor vehicle glass.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1) A vehicle glass protective cover, the cover comprising:
a first layer of protective material;
a second layer of adhesive material attached to a bottom side of the first layer of protective material;
wherein the first layer of protective material is proportioned to fit a motor vehicle.

2) The vehicle glass protective cover of claim 1, wherein the first layer of protective material is tempered glass.

3) The vehicle glass protective cover of claim 1, wherein the adhesive will hold the first layer of protective material in place after an impact.

4) The vehicle glass protective cover of claim 1, wherein the first layer of protective material has a force absorbing quality.

5) The vehicle glass protective cover of claim 1, wherein the adhesive material has a force absorbing quality.

6) A vehicle glass protective cover, the cover comprising:
a first layer of protective material;
a second layer of adhesive material attached to a bottom side of the first layer of protective material;
a third layer of tinting material attached to the first layer of protective material;
wherein the first layer of protective material is proportioned to fit a motor vehicle.

7) The vehicle glass protective cover of claim 1, wherein the first layer of protective material is tempered glass.

8) The vehicle glass protective cover of claim 1, wherein the adhesive will hold the first layer of protective material in place after an impact.

9) The vehicle glass protective cover of claim 1, wherein the first layer of protective material has a force absorbing quality.

10) The vehicle glass protective cover of claim 1, wherein the adhesive material has a force absorbing quality.

11) The vehicle glass protective cover of claim 1, wherein the tinted material has a polarization element.

12) A vehicle glass protective cover, the cover comprising:
a first layer of protective material;
a second layer of adhesive material attached to a bottom side of the first layer of protective material;
wherein the first layer of protective material is proportioned to fit a motor vehicle; and
wherein the protective cover has cutouts specifically placed to form together when the cover is bent to fit over a bent portion of vehicle glass.

13) The vehicle glass protective cover of claim 1, wherein the first layer of protective material is tempered glass.

14) The vehicle glass protective cover of claim 1, wherein the adhesive will hold the first layer of protective material in place after an impact.

15) The vehicle glass protective cover of claim 1, wherein the first layer of protective material has a force absorbing quality.

16) The vehicle glass protective cover of claim 1, wherein the adhesive material has a force absorbing quality.
